(19) United States
(12) Patent Application Publication
(10) Pub. No.: US 2017/0201177 A1
(43) Pub. Date: Jul. 13, 2017

(54) SYSTEM AND METHOD FOR TWO-PHASE INTERLEAVED DC-DC CONVERTERS

(71) Applicant: THE TRUSTEES OF DARTMOUTH COLLEGE, Hanover, NH (US)

(72) Inventors: Kapil KESARWANI, Lebanon, NH (US); Jason T. STAUTH, Hanover, NH (US)

(21) Appl. No.: 15/326,961

(22) PCT Filed: Jul. 17, 2015
(86) PCT No.: PCT/US15/40953

§ 371 Date: Jan. 17, 2017

Related U.S. Application Data
(60) Provisional application No. 62/025,625, filed on Jul. 17, 2014.

(51) Int. Cl. H02M 3/158; H02M 1/14

(52) U.S. Cl. CPC H02M 3/158; H02M 1/14

(57) ABSTRACT

A two-phase interleaved DC-DC converter includes a first and second switched capacitor sub-converter each including a plurality of switching devices and a flying portion coupling to a switching node. The switching node of each of the first and second switched capacitor sub-converters are coupled together to form a common node and an inductor is coupled between the common node and the output node. The two-phase interleaved DC-DC converter may operate at a non-resonant, quasi-resonant or resonant mode of operation.

### RELATED APPLICATIONS

This application claims priority to U.S. Provisional Application Ser. No. 62/025,625, filed Jul. 17, 2014 and which is incorporated by reference in its entirety herewith.

### GOVERNMENT RIGHTS

This invention was made with government support under award number 1309905 awarded by the National Science Foundation. The government has certain rights in the invention.

### BACKGROUND

This invention relates to switched-mode power converters, and particularly to systems and methods for implementing multi-phase interleaving to reduce output voltage ripple when operating a switched-mode power converter at a fixed switching frequency.

Power converters are widely used in a range of electronic and electro-mechanical systems to efficiently process and deliver energy where the energy source may supply power at one voltage level and the load requires a substantially different voltage level. Efficient power converters use switching techniques and energy storage components such as capacitors or inductors to transform voltage and current levels to the levels required by the load. For example, a microprocessor may operate at 1 V and 100 A, but the system power bus or battery provides a 12 V supply. A power converter, in this case a DC-DC converter, is needed to transform the 12 V supply to a 1 V supply that can be used by the microprocessor.

FIG. 1 shows a prior-art behavioral model 100 of switched-capacitor (SC) and resonant switched-capacitor (ReSC) types of converters considering only DC operation. Model 100 may operate as an ideal transformer that converts voltage V_{IN} to substantially Vₒᵤₜ=V_{IN}*M, where M is defined here as the ideal conversion ratio of the converter (M is shown represented by the turns ratio of an equivalent transformer model). By the power conservation of the transformer model, the input and output currents are also scaled by the conversion ratio such that I_{IN} is substantially I_{IN}=M*I_{OUT}.

The parameter R_{EFF} (102) in FIG. 1 represents the effective output resistance of the converter. Calculating R_{EFF} for SC and ReSC converters is known as discussed in: K. Kesarwani, R. Sangwan, and J. T. Stauth, “Resonant Switched-Capacitor Converters for Chip-Scale Power Delivery: Modeling and Design,” IEEE Workshop on Control and Modeling for Power Electronics (COMPEL), 2013, and K. Kesarwani, R. Sangwan, and J. T. Stauth, “A comparative theoretical analysis of distributed ladder converters for sub-module PV energy optimization,” IEEE Workshop on Control and Modeling for Power Electronics (COMPEL), 2012. It is typically desirable to have lower R_{EFF} as this implies lower conduction losses in the circuit and that the conversion ratio will be closer to the ideal conversion ratio when the load is drawing substantial current. Therefore, the ideal conversion ratio may be defined as M=V_{OUT}/V_{IN} for the case where R_{EFF} is substantially zero or I_{IN}=M*I_{OUT} where R_{EFF} is substantially zero.

FIG. 2 depicts a prior-art diagram for a switched capacitor (SC) converter 200. Switched-capacitor converter 200 includes a supply (VDD) 202, an output voltage Vout 204 and output current I_{DC} 206, flying capacitance (Cx) 208, and a plurality of bypass capacitances (Cbp) 210. A plurality of switching devices 212(1)-212(4) are configured to switch the configuration of flying capacitance 208 to control the voltage level of Vout 204.

FIG. 3 depicts a prior-art diagram for a resonant switched capacitor converter 300. FIG. 4 depicts the prior-art operation of ReSC 300, in a first operation state 400. FIG. 5 depicts the prior-art operation of ReSC 300, in a second operation state 500. FIG. 6 depicts the prior-art wave form timing diagram 600 for the ReSC 300, of FIG. 3. FIGS. 3-6 are best viewed together with the following description.

ReSC 300 is similar to SC 200, and includes a voltage supply (VDD) 302, an output voltage Vout 304 and output current I_{DC} 306, flying capacitance (Cx) 308, and a plurality of bypass capacitances (Cbp) 310. ReSC 300 further includes a resonant inductor 314 in series with flying capacitance 308. A plurality of switching devices 312(1)-312(4) operate to switch the configuration of flying capacitance 308 and resonant inductor 314 to control the voltage potential of Vout 304.

ReSC 300 nominally switches at the resonant frequency which is found according to equation 1, below:

$${f}_{0} = \frac{1}{2 π \sqrt{{L}_{X} {C}_{X}}} \qquad ( Equation 1 )$$

In first operation state 400, switches 312(1) and 312(3) are in the closed state and the resonant impedance 316 comprising of R_{ESR}, L_{X} 314 and C_{X} 308 is connected between VDD 302 and V_{OUT} 304 for substantially one half of the resonant time period. During this period, current iₓ approximates a positive half-wave sinusoid, as illustrated in FIG. 6. This current flows through and charges Cₓ 308. In second operation state 500, switches 312(2) and 312(4) are in the closed state and the resonant impedance 316 is connected between the output 304 and ground 301 for substantially the other half of the resonant time period. During this period, current iₓ is a negative half-wave sinusoid and flows through Cₓ into the terminal connected to the output 304, thereby discharging capacitor C, and providing power that can be delivered to the load 306.

Since the switches 312(1) and 312(3) are turned on during the same time interval, clock signals 311(1) and 313(3) are in phase. Similarly, switches 312(2) and 312(4) are driven by clock signals 311(2) and 311(4) respectively which are also in phase. However, it should be noted that because 311(1) and 311(3) (311(2) and 311(4)) operate at different common modes determined by the voltages of their respective source terminals, the actual voltage signals that turns these switches ‘on’ and ‘off’ may also operate at different common mode levels. Also since clock signals 311(1) and 311(3) are turned on for half the switching time period, they are phase shifted by substantially 180° with respect clock signals 311(2) and 311(4) but with some dead-time to prevent overlap of the closed state of switch 312(1) and 312(2) and also to prevent overlap of the closed state of switch 312(3) and 312(4). Therefore in the dead-time period, all switches are in the high impedance open state for a brief time period in between state transitions. Thus, timing diagram 600 illustrates the timing diagram for clock signals 311(1), 311(2), 311(3) and 311(4) and the resonant current in the inductor 314. It should be appreciated that, although not shown, the dead-time 602 exists at the intersection between state 400 and state 500, as indicated by the dashed lines.

Further details of the operation of switched capacitor converters 200 and 300 are discussed in J. T. Stauth, M. D. Seeman, and K. Kesarwani, “A Resonant Switched-Capacitor IC and Embedded System for Sub-Module Photovoltaic Power Management,” IEEE Journal of Solid-State Circuits, 2012; Stauth, J. T., Seeman, M. D., Kesarwani, K., “A high-voltage CMOS IC and embedded system for distributed photovoltaic energy optimization with over 99% effective conversion efficiency and insertion loss below 0.1%,” IEEE International Solid-State Circuits Conference Digest of Technical Papers (ISSCC), 2012; and Stauth, J. T., Seeman, M. D., Kesarwani, K., “Resonant Switched-Capacitor Converters for Sub-module Distributed Photovoltaic Power Management,” IEEE Transactions on Power Electronics, 2013.

FIG. 7 depicts a prior-art three-level buck DC-DC converter 700. Three-level buck converter 700 is a combination of switched-capacitor converter 200 further including a step-down (buck) DC-DC converter that uses an inductor 720. Additional description of the three-level buck D-DC converter can be found in “Yousefzadeh, V., Alarcón, E., & Maksimovic, D.,” Three-Level Buck Converter for Envelope Tracking Applications,” IEEE Transactions on Power Electronics, 2006, “Kim, W., Brooks, D. M., & Wei, G.,” A Fully-Integrated 3-Level DC-DC Converter for Nanosecond-Scale DVFS,” IEEE Journal of Solid-State Circuits, 2012.

The above converters 200 and 300 have been modified to utilize multi-phase interleaving techniques to reduce the size of the output capacitor at a given switching frequency and load current while maintaining a constant output voltage ripple.

FIG. 8 depicts a prior-art two-phase interleaved two-to-one ReSC 800. ReSC 800 is similar to the converter discussed in K. Kesarwani, R. Sangwan, and J. T. Stauth, “A 2-phase Resonant Switched-Capacitor Converter Delivering 4.3 W at 0.6 W/mm2 With 85% Efficiency”, IEEE International Solid-State Circuits Conference Digest of Technical Papers (ISSCC), 2014. ReSC 800 operates with two resonant switched capacitor stages, 880 and 890 interleaved with an 180° phase shift. The 180° phase shift is used to minimize the output voltage ripple by providing a half-wave rectified sinusoid of current to the load in each half of the switching period.

Clock signals S1 (811(1)) and S3 (811(3)) are in-phase and they are complementary with clock signals S2 (811(2)) and S4 (811(4)) respectively. The clock signals S5-S8 (811(5)-(811(8)) will be 180° out of phase with clock signals S1-S4 (811(1)-(811(4)) respectively because of interleaving. This directly implies that clock signals S1, S3, S6 and S8 are in-phase; additionally, clock signals S2, S4, S5 and S7 are in phase with each other, but out of phase with clock signals S1, S3, S6, and S8. There is some dead-time to prevent overlap of the closed state of switch pairs S1-S2, S3-S4, S5-S6, and S7-S8 which prevents direct current conduction between VDD and Vout and between Vout and ground.

FIGS. 9 and 10 show the operation of the converter 800 of FIG. 8 in the two states 900, 1000, respectively, of operation. In state 900, switches M1 (812(1)), M3 (812(3)), M6 (812(6)), and M8 (812(8)) are on and in state 1000, switches M2 (812(2)), M4 (812(4)), M5 (812(5)), and M7 (812(7)) are on.

In typical operation, the resonant impedance 816 is the same in both the phases 900 and 1000. This implies that R_{ESR1}=R_{ESR2}=R_{ESR}, L_{X1}=L_{X2}=L_{X} and C_{X1}=C_{X2}=C_{X}. Assuming the bypass capacitors (Cbp) are substantially larger than the flying capacitors (Cx), the resonant frequency and Q of the circuit is then given by the following equations.

$$\begin{matrix}{f}_{0} = \frac{1}{2 π \sqrt{{L}_{X} {C}_{X}}} & ( Equation 2 ) \\ Q = \frac{1}{{R}_{ESR}} \sqrt{\frac{{L}_{X}}{{C}_{X}}} & ( Equation 3 )\end{matrix}$$

### SUMMARY OF THE INVENTION

In one aspect of the invention disclosed herewith, a two-phase interleaved DC-DC converter, includes: a first and second switched capacitor sub-converter each including a flying capacitor, and a plurality of switching devices capable of coupling the flying capacitor in configurations including (i) between an input voltage node and a switching node, and (ii) between the switching node and ground; wherein the switching node of each of the first and second switched capacitor sub-converters are coupled together to form a common node; and an inductor coupled between the common node and an output node.

### BRIEF DESCRIPTION OF THE FIGURES

FIG. 1 shows a prior-art behavioral model of SC and ReSC types of converters considering only DC operation.

FIG. 2 depicts a prior-art diagram for a switched capacitor converter.

FIG. 3 depicts a prior-art diagram for a resonant switched capacitor converter.

FIG. 4 depicts the prior-art operation of ReSC, in a first operation state.

FIG. 5 depicts the prior-art operation of ReSC 300, in a second operation state.

FIG. 6 depicts the prior-art wave form timing diagram for the ReSC, of FIG. 3.

FIG. 7 depicts a prior-art three-level buck DC-DC converter.

FIG. 8 depicts a prior-art two-phase interleaved two-to-one ReSC.

FIGS. 9 and 10 show the operation of the converter of FIG. 8 in the two states, respectively, of operation.

FIG. 11 depicts a two-phase interleaved DC-DC converter, in one embodiment.

FIG. 12 depicts a simplified diagram illustrating configuration of the converter of FIG. 11 in a first operating state.

FIG. 13 depicts a simplified diagram illustrating configuration of the two-phase interleaved DC-DC converter of FIG. 11, in a second operating state.

FIG. 14 depicts a circuit diagram of the prior art ReSC of FIG. 8, including numerical values used for the elements of the circuit in an exemplary SPICE simulation.

FIG. 15 depicts SPICE results for operation of ReSC, of FIG. 8, using the numerical values depicted in FIG. 14.

FIG. 16 depicts a circuit diagram of the two-phase interleaved DC-DC converter of FIG. 11, including numerical values used for each element of the circuit in an exemplary SPICE simulation.

FIG. 17 depicts SPICE results for operation of the two-phase interleaved DC-DC converter of FIG. 11, using the numerical values depicted in FIG. 16.

FIGS. 18-21 depict various states of the converter of FIG. 11 based upon configurations of the clock signals such that the duty cycle is greater than 0.5.

FIGS. 22-25 depict various states of converter of FIG. 11 based upon configurations of the clock signals such that the duty cycle is less than 0.5.

FIG. 26 depicts the voltage potential V_{SW} at the switching node of the converter of FIG. 11 and the current iₓ through the inductor in each of the states of FIG. 18-21.

FIG. 27 depicts the voltage potential V_{SW} at switching node of the converter of FIG. 11 and the current iₓ through the inductor in each of the states of FIG. 22-25.

FIGS. 28 and 29 show waveforms for the inductor current (iₓ), switching node voltage (V_{X}) and the output voltage (V_{OUT}) with output voltage higher than V_{DD}/2 and lower than V_{DD}/2 respectively.

FIG. 30 depicts a circuit diagram of the two-phase interleaved DC-DC converter of FIG. 11, including numerical values used for each element of the circuit in the exemplary SPICE simulation of FIGS. 28 and 29.

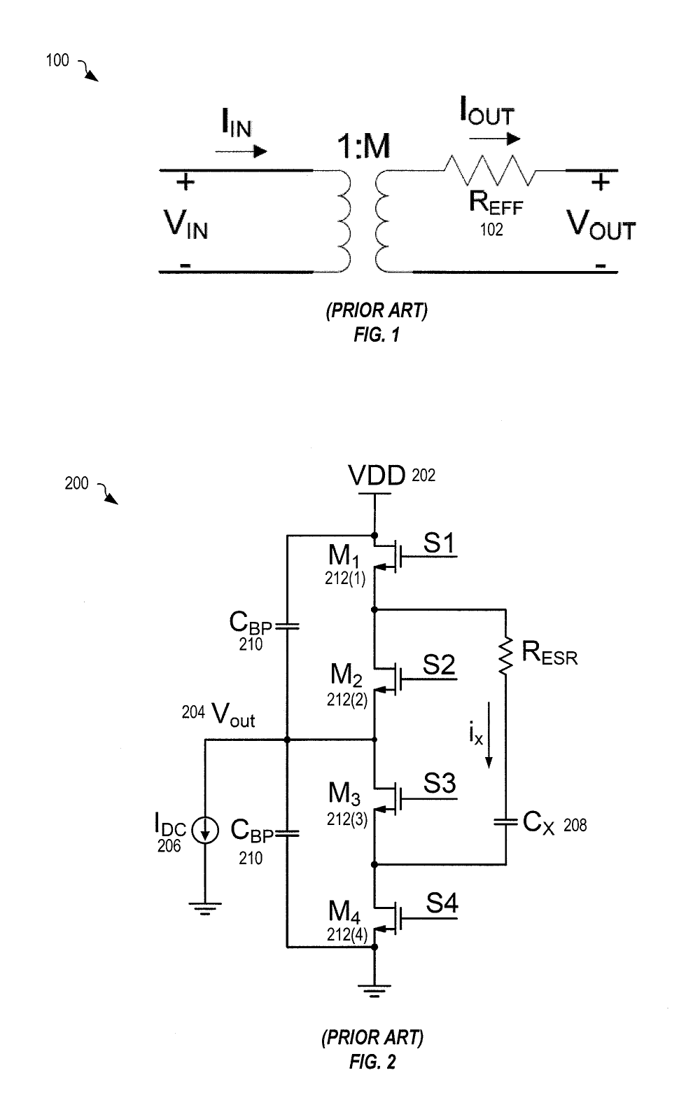

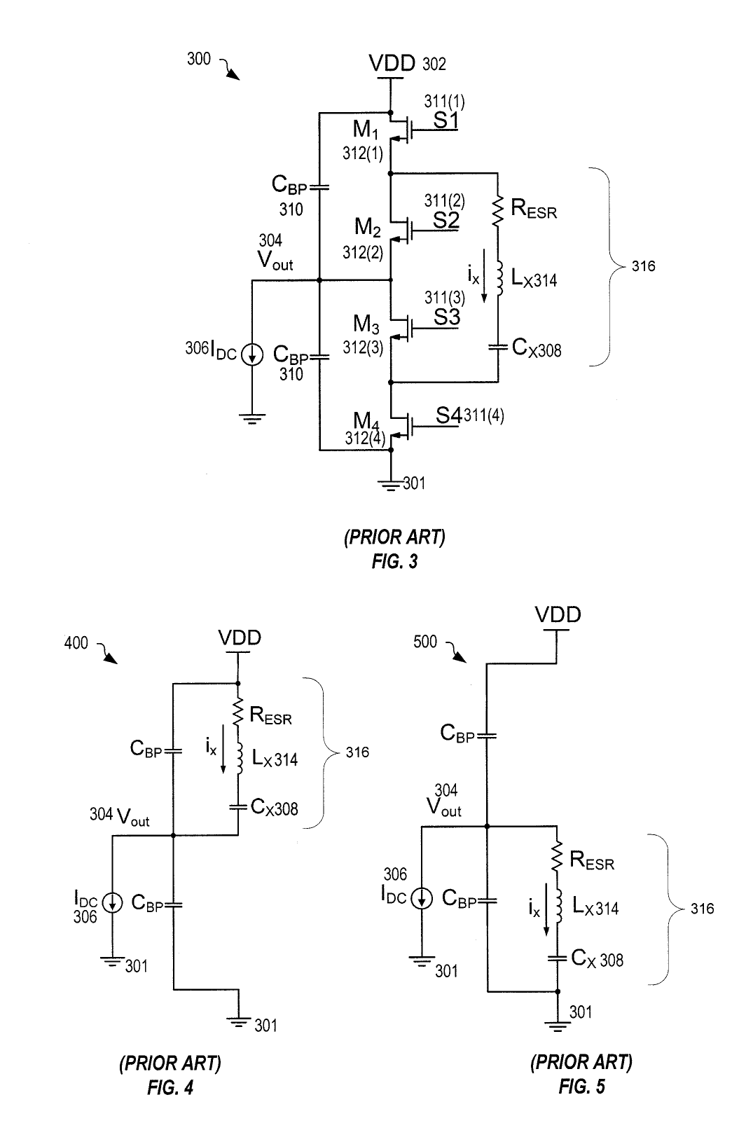

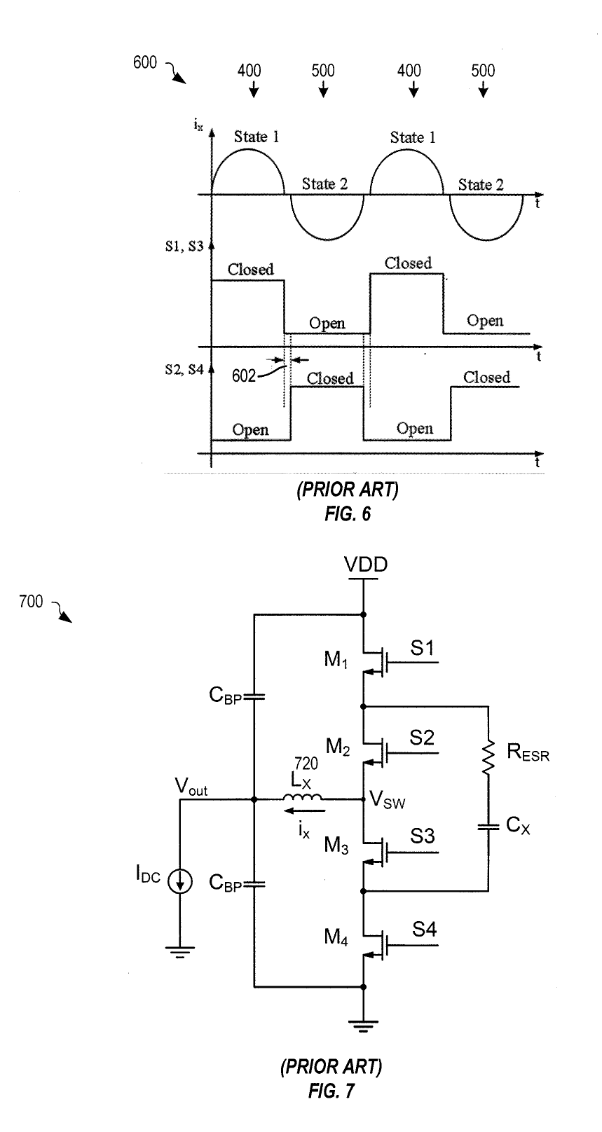

### DETAILED DESCRIPTION OF THE DRAWINGS

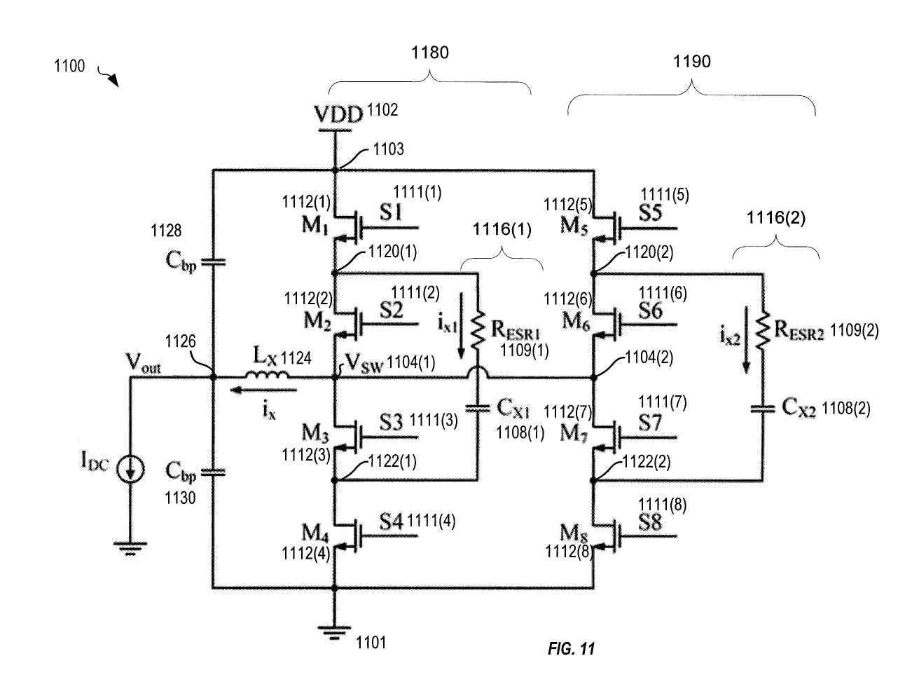

FIG. 11 depicts a two-phase interleaved DC-DC converter 1100, in one embodiment. Two-phase interleaved DC-DC converter 1100 includes a first switched capacitor sub-converter 1180 interleaved with a second switched capacitor sub-converter 1190.

First switched capacitor sub-converter 1180 includes a first plurality of first switching devices 1112(1)-1112(4). Switching devices 1112(1) and 1112(3) are controlled by clock signals 1111(1) and 1111(3), respectively. Switching devices 1112(2) and 1112(4) are operated by a second clock signal 1111(2) and 1111(4), respectively. Clock signals 1111(1) and 1111(3) are in-phase (synchronous) such that the open and closed states of switching devices 1112(1) and 1112(3) occur in the same time interval. Clock signals 1111(2) and 1111(4) are in-phase (synchronous) such that the open and closed states of switching devices 1112(2) and 1112(4) occur in the same time interval. Clock signals 1111(1) and 1111(3) are phase-shifted by 180 degrees with respect to clock signals 1111(2) and 1111(4) such that the open and closed states of switching devices 1112(1) and 1112(3) are substantially complimentary to the open and closed states of switching devices 1112(2) and 1112(4). It should be appreciated that there may be some dead-time between clock signals 1111(1) and 1111(2) and correspondingly between clock signals 1111(3) and 1111(4) to prevent overlap of the closed states of switching devices 1112(1) and 1112(2) as well as the closed states of switching devices 1112(3) and 1112(4).

First switched capacitor sub-converter 1180 further includes a first flying portion 1116(1), including a first flying capacitor 1108(1), coupled between a first flying node 1120(1) and a second flying node 1122(1) of the first switched capacitor sub-converter 1180. Resistor R_{ESR1} 1109(1) may not be an explicit circuit component but models the equivalent series resistance of the loop containing the switching devices, flying capacitance, bypass capacitance, and parasitic circuit interconnect resistance. Within first switched capacitor sub-converter 1180, first switching device 1112(1) is electrically coupled between an input node 1103, coupled to input voltage VDD 1102, and first flying node 1120(1); second switching device 1112(2) is electrically coupled between first flying node 1120(1) and a first switching node 1104(1); third switching device 1112(3) is electrically coupled between first switching node 1104(1) and second flying node 1122(1); and fourth switching device 1112(4) is electrically coupled between second flying node 1122(1) and ground 1101.

Second switched capacitor sub-converter 1190 includes a second plurality of first switching devices 1112(5)-1112(8). Switching devices 1112(6) and 1112(8) are operated by clock signals 1111(6) and 1111(8), respectively. Switching devices 1112(5) and 1112(7) are operated by clock signals 1111(5) and 1111(7), respectively. Clock signal 1111(5) is in-phase (synchronous) with clock signal 1111(7), such that the open and closed states of switching devices 1112(5) and 1112(7) occur in the same time interval. Clock signals 1111(6) and 1111(8) are in-phase (synchronous) such that the open and closed states of switching devices 11132(60 and 1112(8) occur in the same time interval. Clock signals 1111(5) and 1111(7) are phase shifted by 180 degrees with respect to clock signals 1111(6) and 1111(8) such that the open and closed states of switching devices 1112(5) and 1112(7) are substantially complimentary with the open and closed states of switching devices 1112(6) and 1112(8). It should be appreciated that there may be some dead-time between clock signals 1111(5) and 1111(6) and correspondingly between clock signals 1111(7) and 1111(8) to prevent overlap of the closed states of switching devices 1112(5) and 1112(6) as well as the closed states of switching devices 1112(7) and 1112(8).

Second switched capacitor sub-converter 1190 further includes a second flying portion 1116(2), including a second flying capacitor 1108(2), between a first flying node 1120(2) and a second flying node 1122(2) of the second switched capacitor sub-converter 1190. Resistor R_{ESR2} 1109(2) may not be an explicit circuit component but models the equivalent series resistance of the loop containing the switching devices, flying capacitance, bypass capacitance, and parasitic circuit interconnect resistance of the second switched capacitor sub-converter. Within second switched capacitor sub-converter 1190, first switching device 1112(5) is electrically coupled between input node 1103, coupled to input voltage VDD 1102, and first flying node 1120(2) of second switched capacitor 1190; second switching device 1112(6) is electrically coupled between first flying node 1120(2) and a second switching node 1104(2) of second switched capacitor 1190; third switching device 1112(7) is electrically coupled between second switching node 1104(2) and second flying node 1122(2); and fourth switching device 1112(8) is electrically coupled between second flying node 1122(2) and ground 1101. First switching node 1104(1) of first switched capacitor 1180 and second switching node 1104(2) of second switched capacitor 1190 are coupled together as a common node. Additionally, clock signals 1111(5)-1111(8) of second switched capacitor sub-converter 1190 are phase shifted by substantially 180 degrees from clock signal 1111(1)-1111(4) respectively of first switched capacitor sub-converter 1180. With this operation, the switching states of first switched capacitor sub-converter 1180 are phase shifted by substantially 180 degrees from the switching states of second switched capacitor sub-converter 1190. Accordingly, switched-capacitor sub-converters 1180 and 1190 operate in a two-phase interleaved mode.

As discussed above, first switched capacitor sub-converter 1180 and second switched capacitor sub-converter 1190 share a common switching node 1104. Two-phase interleaved DC-DC converter 1100 further includes an inductor 1124 coupled between common switching node 1104 and an output node 1126. Two-phase interleaved DC-DC converter 1100 further includes a first bypass capacitor 1128 coupled between output node 1126 and input node 1103; and a second bypass capacitor 1130 coupled between output node 1126 and ground 1101. Alternatively, and although not shown, two-phase interleaved DC-DC converter 1100 may be configured with a bypass capacitor coupled between input node 1103 and ground 1101. In this case, only one of bypass capacitors 1130 and 1128 may be needed to filter the output voltage and ensure resonant operation.

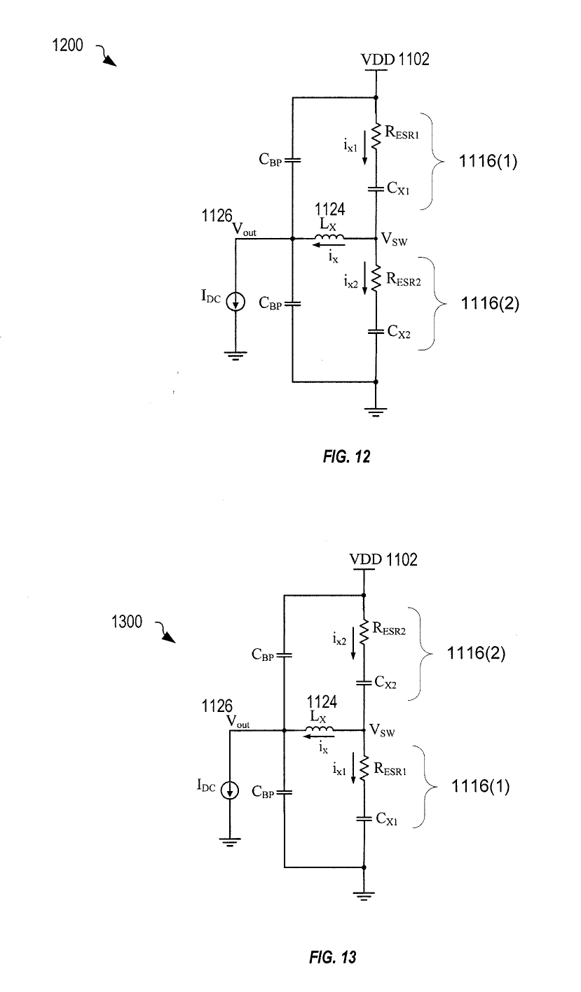

FIG. 12 depicts a simplified diagram illustrating configuration of two-phase interleaved DC-DC converter 1100, of FIG. 11, in a first operating state 1200. State 1200 is configured when switching devices M1 1112(1), M3 1112(3), M6 1112(6), and M8 1112(8) are in the closed state, as controlled by clock signals S1 1111(1), S3 1111(3), S6 1111(6), and S8 1111(8) respectively. Correspondingly, switching devices M2 1112(2), M4 1112(4), M5 1112(5), and M7 1112(7) are in an open or high-impedance state.

FIG. 13 depicts a simplified diagram illustrating configuration of two-phase interleaved DC-DC converter 1100, of FIG. 11, in a second operating state 1300. State 1300 is configured when switching devices M2 1112(2), M4 1112(4), M5 1112(5), and M7 1112(7) are in the closed state, as controlled by clock signals S2 1111(2), S4 1111(4), S5 1111(5), and S7 1111(7) respectively. Correspondingly, switching devices M1 1112(1), M3 1112(3), M6 1112(6), and M8 1112(8) are in an open or high-impedance state.

It is evident from FIGS. 12 and 13 that operating states 1200 and 1300 provide effective two-phase interleaving of switched-capacitor sub-converters 1180 and 1190. Furthermore, because flying capacitors C_{X1} 1108(1) and C_{X2} 1108(2) are coupled to a common node, V_{SW} 1104, the capacitance value that sets the resonant frequency is the sum of C_{X1} and C_{X2} (assuming the bypass capacitors, Cbp, are large relative to flying capacitors, Cx). This can be expressed by the Thevenin-equivalent capacitance in series with inductor, L_{X} 1124, through which current iₓ flows, again assuming bypass capacitors, C_{BP}, are large relative to flying capacitors, C_{X}, and that input voltage V_{DD} is connected to a high-impedance source such as a current source or relatively large inductance:

C_{X}_{_}_{TH}=C_{X1}+C_{X2} (Equation 4)

while the Thevinen-equivalent resistance of the switches and flying capacitors is:

R_{ESR}_{_}_{TH}(R_{ESR1}+R_{ESR2})/2 (Equation 5)

In other words, the flying capacitances in the two interleaved phases add while the effective series resistance of the capacitors and switches halves. In typical operation with C_{X1}=C_{X2} and R_{ESR1}=R_{ESR2}, the resonant impedance will be same in both the phases. Accordingly, two-phase interleaved DC-DC converter 1100 may operate according to the condition that R_{ESR1}=R_{ESR2}=R_{ESR}, L_{X1}=L_{X2}=L_{X} and C_{X1}=C_{X2}=C_{X}. Under this condition, the resonant frequency of the circuit is then given by the following equation:

$${f}_{0} = \frac{1}{2 π \sqrt{{L}_{X} ( 2 {C}_{X} )}} \qquad ( Equation 6 )$$

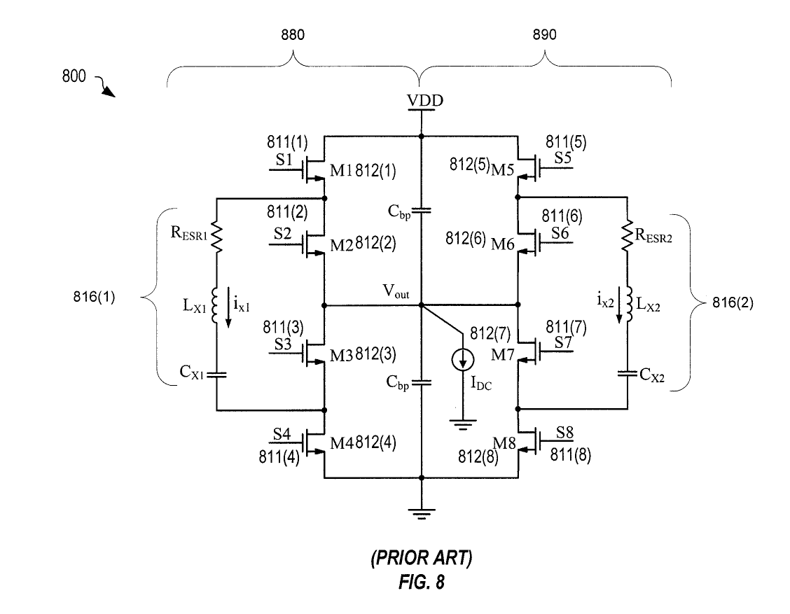

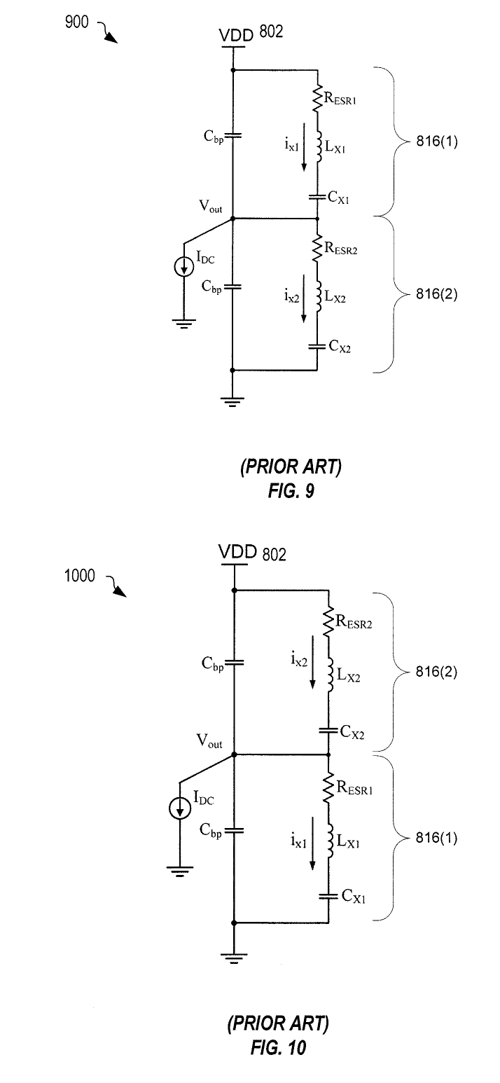

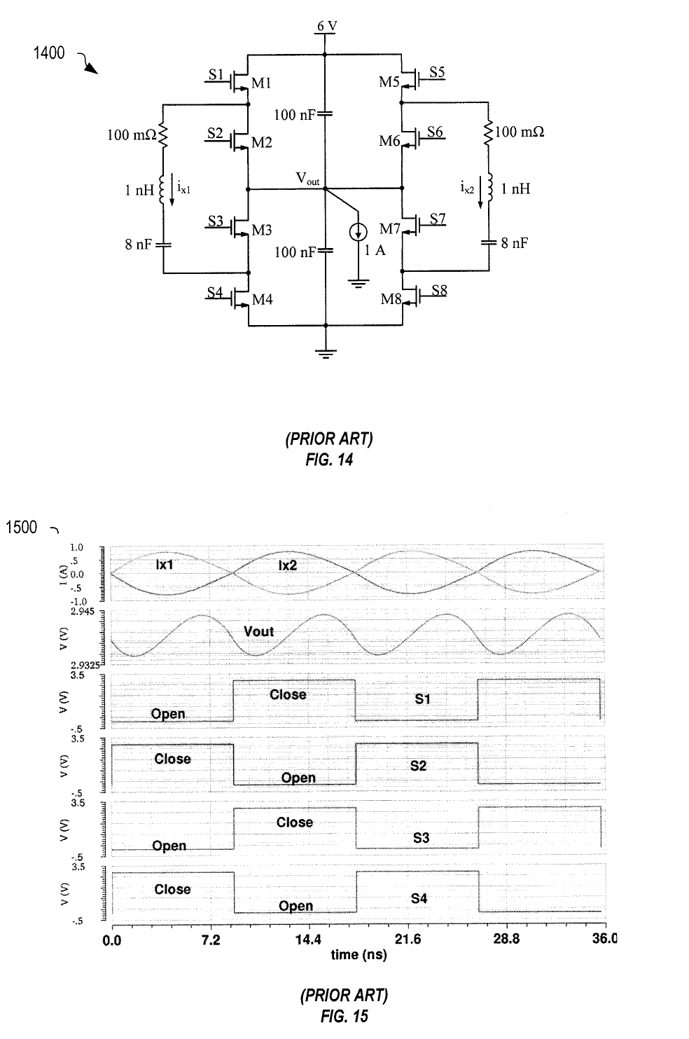

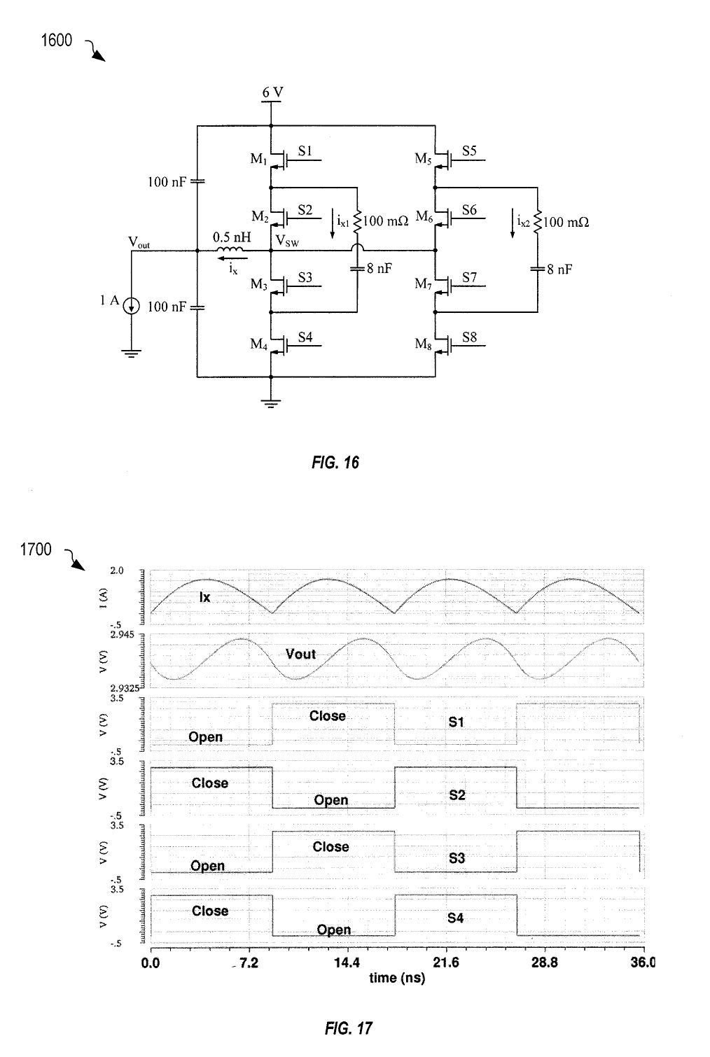

FIG. 14 depicts a circuit diagram 1400 of the prior art ReSC 800, of FIG. 8, including numerical values used for the elements of the circuit in an exemplary SPICE simulation. FIG. 15 depicts SPICE results 1500 for operation of ReSC 800, of FIG. 8, using the numerical values depicted in FIG. 14. FIG. 16 depicts a circuit diagram 1600 of the two-phase interleaved DC-DC converter 1100, of FIG. 11, including numerical values used for each element of the circuit in an exemplary SPICE simulation. FIG. 17 depicts SPICE results 1700 for operation of two-phase interleaved DC-DC converter 1100, of FIG. 11, using the numerical values depicted in FIG. 16. FIGS. 14-17 are best viewed together with the following description.

As can be seen by a comparison of FIG. 14 against FIG. 16, the bypass capacitances within the circuits have the same values (100 nF), the effective series resistance within the two circuits have the same values (100 mΩ), and the flying capacitances between the two circuits have equivalent values (8 nF). However, importantly, the frequency of operation for both circuits is the same and the DC output voltage and AC voltage ripple are substantially the same. The peak current iₓ in the inductor in circuit 1600 is double the peak current in the inductors iₓ₁ and iₓ₂ in circuit 1400 because the proposed topology uses only one inductor and thus all the current flows through it.

Since the switching frequency for the merged two-phase interleaved DC-DC converter 1600 and the prior-art converter 1400 is same, the switching losses will also be same for both of them, assuming use of similar switching devices between the two converters and similar operating conditions. The effective resistance is also same for both converters because the output and input and voltages are same for both converters. In practice, two-phase interleaved DC-DC converter 1600 will contribute much lower series-resistance in the inductor because a substantial portion of the current in the inductor is DC. As it is known that inductors typically have higher effective series resistance at higher frequency, by delivering a substantial portion of the load current at DC, the net effective series resistance of the inductor may be lower for the merged interleaved converter 1600. This will lead to lower effective resistance and higher efficiency for merged interleaved converter.

In another embodiment, the two-phase interleaved DC-DC converter 1100 in FIG. 11 is controlled using a plurality of states similar to the plurality of states used in the prior art 3-level buck converter 700. The difference is the use of two switched-capacitor sub-converters 1180 and 1190 to implement two-phase interleaving with a single inductor component. To operate the converter in the plurality of states, two-phase interleaved DC-DC converter 1100 may include a controller, not shown, to vary a duty cycle “D” of the converter 1100. Duty cycle ratio “D” refers to the ratio of the time period for which clock signals 1111(1) and 1111(2) are high relative to the total switching time period (T_{SW}).

For example, FIGS. 18-21 depict various states 1800-2100 of converter 1100, of FIG. 11 based upon configurations of clock signals 1111(1) through 1111(8) with a duty cycle, D, greater than 0.5 such that output voltage greater than V_{DD}/2 may be achieved. To achieve state 1800, of FIG. 18, a controller operates clock signals 1111(2), 1111(4), 1111(5), and 1111(7) such that switching devices 1112(2), 1112(4) of first switched capacitor sub-converter 1180, and switching devices 1112(5) and 1112(7) of second switched capacitor sub-converter 1190 are in the closed state for a time equivalent to (1-duty cycle “D”) times the total switching time T_{SW}, where T_{SW} is equivalent to the period of each of clock signals 1111(1) through 1111(8), or equivalently, a full switching cycle of converter 1100. Within state 1800, flying portion 1116(2) is coupled between VDD 1102 and the switching node 1104. And flying portion 1116(1) is coupled between the switching node 1104 and ground 1101.

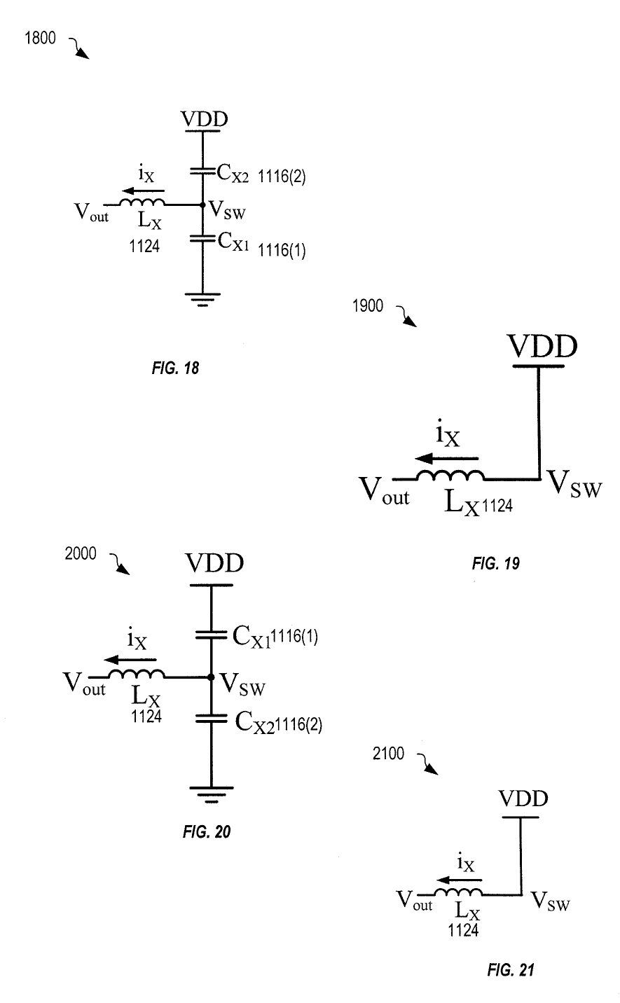

To achieve state 1900, of FIG. 19, a controller operates clock signals 1111(1), 1111(2), 1111(5), and 1111(6) such that switching devices 1112(1), 1112(2) of first switched capacitor sub-converter 1180, and switching devices 1112(5) and 1112(6) of second switched capacitor sub-converter 1190 are in the closed state for a time equivalent to (D−0.5) times the total switching time T_{SW}. Within state 1900, neither of the negative nodes 1122(1) or 1122(2) of the flying portions 1116(1) or 1116(2) are coupled to the switching terminal 1104 or ground 1101 such that the flying portions are in a high impedance state. Correspondingly, Vout is directly coupled to V_{DD} 1102 through inductor 1124.

To achieve state 2000, of FIG. 20, a controller operates clock signals 1111(1), 1111(3), 1111(6), and 1111(8) such that switching devices 1112(1), 1112(3) of first switched capacitor sub-converter 1180, and switching devices 1112(6) and 1112(8) of second switched capacitor sub-converter 1190 are on for a time equivalent to (1−D) times the total switching time T_{SW}. Within state 2000, flying portion 1116(1) is coupled between V_{DD} 1102 and the switching node 1104. And flying portion 1116(2) is coupled between the switching node 1104 and ground 1101.

To achieve state 2100, of FIG. 21, a controller operates clock signals 1111(1), 1111(2), 1111(5), and 1111(6) such that switching devices 1112(1), 1112(2) of first switched capacitor sub-converter 1180, and switching devices 1112(5) and 1112(6) of second switched capacitor sub-converter 1190 are on for a time equivalent to (D−0.5) times the total switching time T_{SW}. Within state 2100, neither of the negative terminals 1122(1) or 1122(2) of the flying portions 1116(1) or 1116(2) are coupled to the switching terminal 1104 or ground 1101, such that the flying portions are in a high impedance state. Correspondingly, Vout is directly coupled to Vdd 1102 through inductor 1124.

States 1800, of FIG. 18, and 2000 of FIG. 20 may operate for a time period sufficient to complete a resonant transition of energy from the flying capacitance 1108 to the output node 1126. In resonant operation of states 1800 and 2000, the switching process completes when the inductor current is substantially zero (equivalently described herein as a “zero current switching” transition). Therefore resonant operation allows the converter to complete a zero-current switching transition at the end of the time period of states 1800 and 2000. States 1800 and 2000 may also operate for a time period substantially shorter than the resonant time period. In this case the converter operates similarly to the prior-art three-level converter except that two-phase interleaving is achieved by using the two-phase interleaved DC-DC converter stages 1180 and 1190.

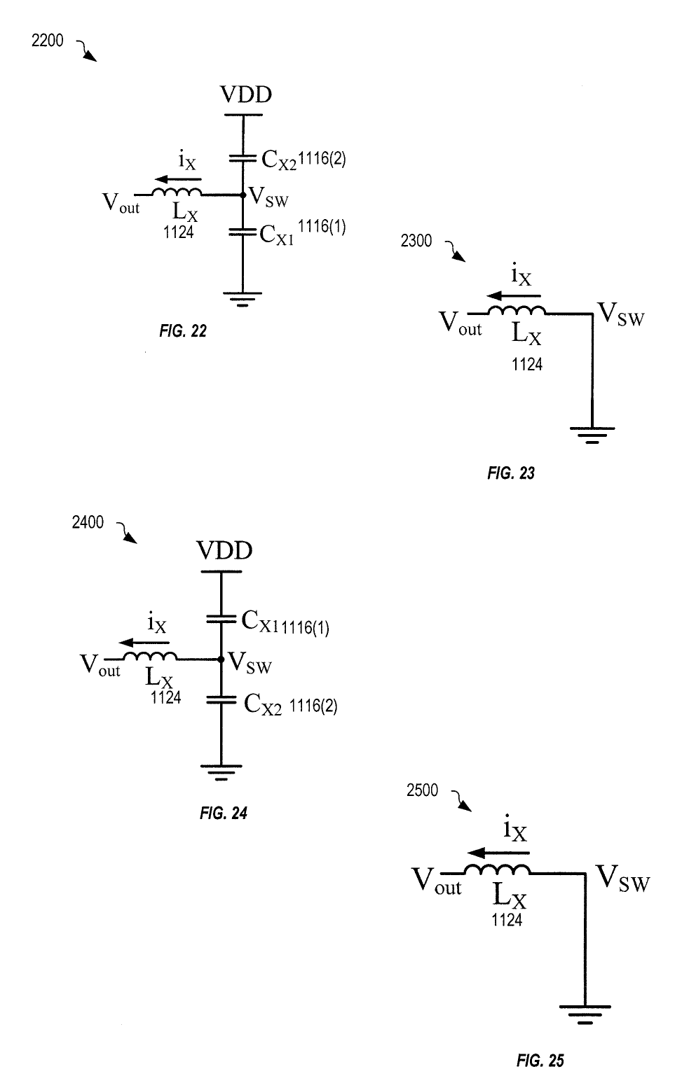

FIGS. 22-25 depict various states 2200-2500 of converter 1100, of FIG. 11 based upon configurations of clock signals 1111(1) through 1111(8) with duty cycle, D, less than 0.5, such that output voltage less than V_{DD}/2 may be achieved. To achieve state 2200, of FIG. 22, a controller operates clock signals 1111(2), 1111(4), 1111(5), and 1111(7) such that switching devices 1112(2), 1112(4) of first switched capacitor sub-converter 1180, and switching devices 1112(5) and 1112(7) of second switched capacitor sub-converter 1190 are in the closed state for a time equivalent to duty cycle “D” times the total switching time T_{SW}. Within state 2200, flying portion 1116(2) is coupled between VDD 1102 and the switching node 1104(2), and flying portion 1116(1) is coupled between the switching node 1104(1) and ground 1101.

To achieve state 2300, of FIG. 23, a controller operates clock signals 1111(3), 1111(4), 1111(7), and 1111(8) such that switching devices 1112(3), 112(4) of first switched capacitor sub-converter 1180, and switching devices 1112(7) and 1112(8) of second switched capacitor sub-converter 1190 are on for a time equivalent to (0.5−D) times the total switching time T_{SW}. Within state 2300, neither of the positive terminals 1120(1) or 1120(2) of the flying portions 1116(1) or 1116(2) are coupled to the switching terminal 1104 or V_{DD} 1102, such that the flying portions are in a high impedance state. Correspondingly, Vout is directly coupled to ground 1101 through inductor 1124.

To achieve state 2400, of FIG. 24, a controller operates clock signals 1111(1), 1111(3), 1111(6), and 1111(8) such that switching devices 1112(1), 1112(3) of first switched capacitor sub-converter 1180, and switching devices 1112(6) and 1112(8) of second switched capacitor sub-converter 1190 are on for a time equivalent to D times the total switching time T_{SW}. Within state 2400, flying portion 1116(1) is coupled between VDD 1102 and the switching node 1104. And flying portion 1116(2) is coupled between the switching node 1104 and ground 1101.

To achieve state 2500, of FIG. 25, a controller operates clock signals 1111(3), 1111(4), 1111(7), and 1111(8) such that switching devices 1112(3), 1112(4) of first switched capacitor sub-converter 1180, and switching devices 1112(7) and 1112(8) of second switched capacitor sub-converter 1190 are on for a time equivalent to (0.5−D) times the total switching time T_{SW}. Within state 2500, neither of the positive terminals 1120(1) or 1120(2) of the flying portions 1116(1) or 1116(2) are coupled to the switching terminal 1104 or V_{DD} 1102, such that the flying portions are in a high impedance state. Correspondingly, Vout is directly coupled to ground 1101 through inductor 1124.

States 2200, of FIG. 22, and 2400 of FIG. 24 may operate for a time period sufficient to complete a resonant transition of energy from the flying capacitance 1108 to the output node 1126. In resonant operation of states 2200 and 2400, the switching process completes when the inductor current is substantially zero. Therefore resonant operation allows the converter to complete a zero-current switching transition at the end of the time period of states 2200 and 2400. States 2200 and 2400 may also operate for a time period substantially shorter than the resonant time period. In this case the converter operates similarly to the prior-art three-level converter except that two-phase interleaving is achieved by using the two-phase interleaved DC-DC capacitor stages 1180 and 1190.

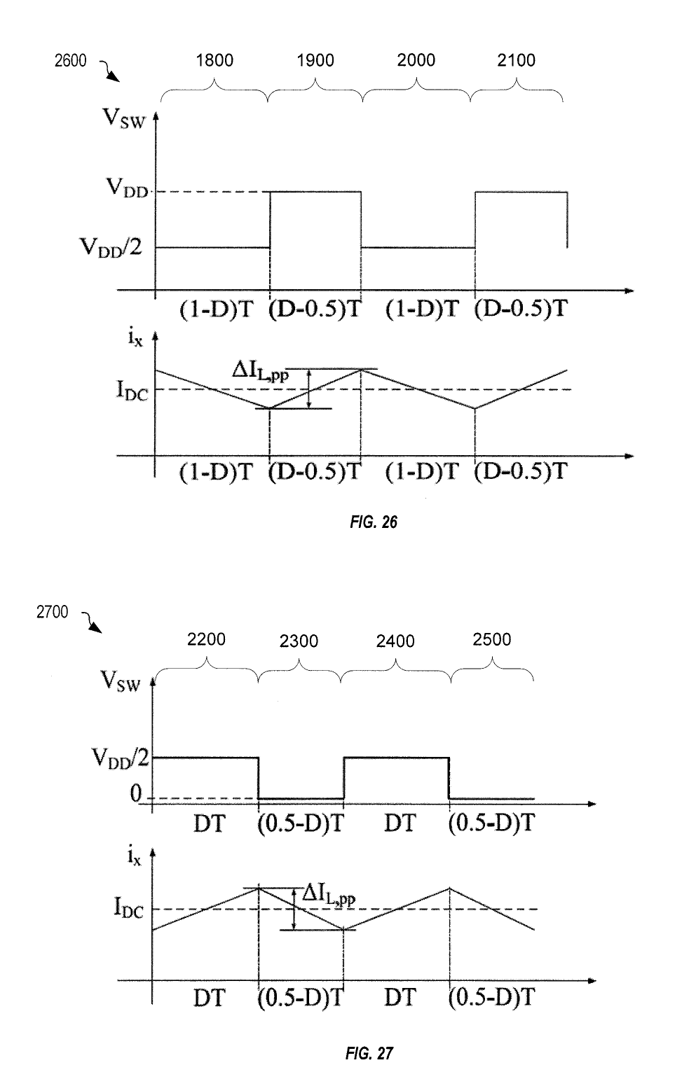

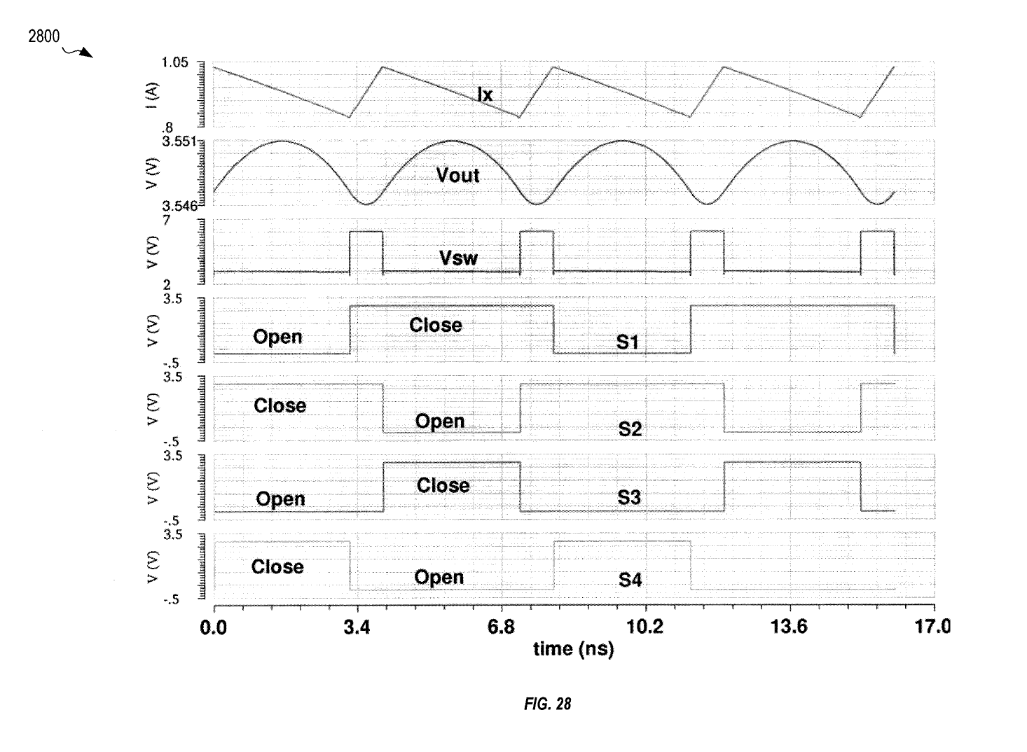

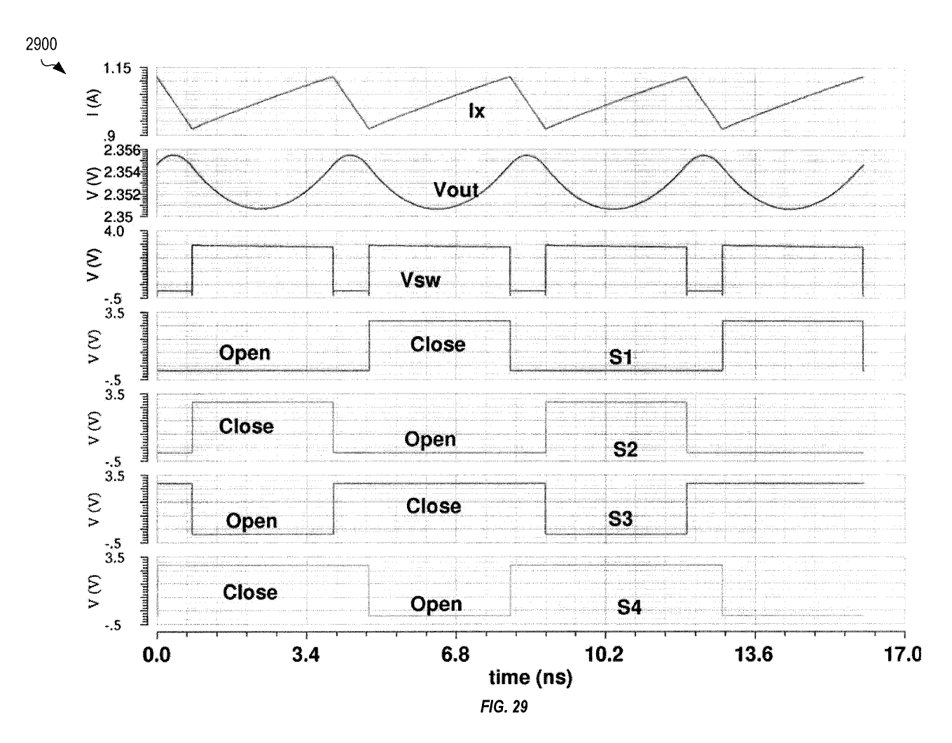

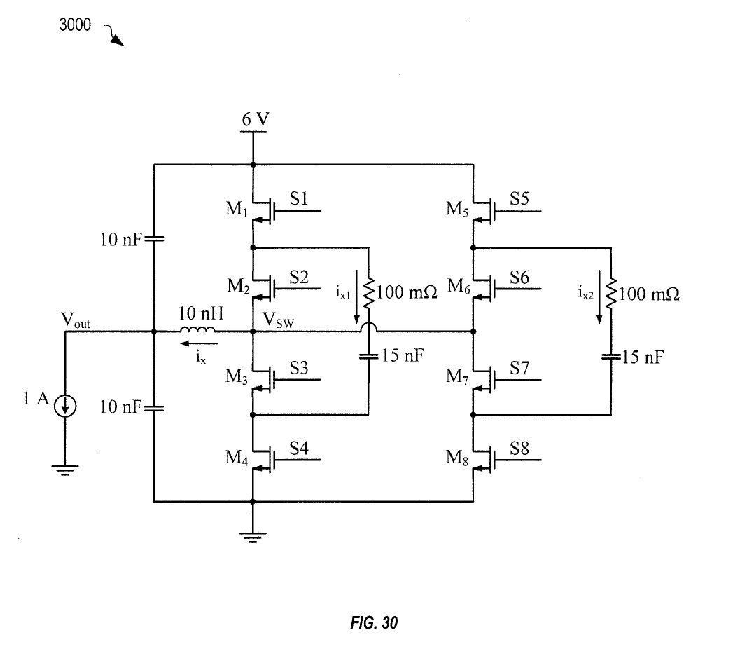

FIG. 26 depicts the voltage potential V_{SW} at switching node 1104 of FIG. 11 and the current iₓ through inductor 1124 in each of the states of FIG. 18-21 for the case that the switching time period in each state is much shorter than a resonant time period in the converter. FIG. 27 depicts the voltage potential V_{SW} at switching node 1104 of FIG. 11 and the current iₓ through inductor 1124 in each of the states of FIG. 22-25. FIGS. 28 and 29 show waveforms 2800, 2900, respectively simulated in spice for the converter 3000 in FIG. 30 operating at a switching frequency of 125 MHz which is much higher than the resonant frequency of the converter (9.2 MHz) to show operation in the non-resonant mode.

FIGS. 28 and 29 show waveforms 2800 and 2900, respectively, for the inductor 1124 current (iₓ), switching node 1104 voltage (V_{X}) and the output voltage (V_{OUT}) with output voltage higher than V_{DD}/2 and lower than V_{DD}/2 respectively. The switching frequency is 125 MHz which is much higher that the resonant switching frequency (9.2 MHz) of the circuit.

Operation of converter 1100 may occur in non-resonant, quasi-resonant, or resonant modes. For example, a controller may control clock signals 1111(1) thru 1111(8) such that converter 1100 is in a plurality of different states. That is, converter 1100 may cycle through a plurality of states 1800-2500, discussed above. Non-resonant mode of operation occurs when the switching frequency is greater than the resonant frequency of converter 1100 for every state. Quasi-resonant mode of operation occurs when the states shown in FIGS. 18, 20, 22, and 24 are of a time duration such that the inductor current is substantially zero at the end of the state and the transition to the next state can occur with a zero current switching transition. Resonant operation occurs when the converter only uses the states shown in FIGS. 18, 20, 22, and 24 and the time duration of these states is such that the inductor current is substantially zero at both the beginning and the end of the operating state such that the converter can make zero current switching transitions on all state transitions. Typical operation in this state occurs at a frequency substantially equal to the fundamental resonant frequency established by the flying capacitors, C_{X} 1108, bypass capacitors, C_{BP} 1128 and 1130, and the parasitic resistance in the resonant loop, R_{ESR} 1109.

Two-phase interleaved DC-DC converter 1100, discussed above, provides significant advantages over the prior art. For example by merging the two complimentary phases, the inductor count can be reduced by half. Moreover, if the switching frequency needs to be kept the same to keep output voltage ripple the same, the inductance value can further be reduced by half. Additionally, switching frequency (and frequency dependent power loss) goes down due to effective parallelization of the two complimentary phases. Further yet, the inductor current waveform has a substantial DC component which reduces power loss due to current conduction (the power in high-frequency harmonics of current in the inductor is lower with respect to the DC current flowing to the load; because high-frequency resistance of inductors is typically larger than low frequency resistance, power losses are reduced). Therefore, two-phase interleaved DC-DC capacitor 1100 is significantly more effective and less costly due to the fewer inductor, lower inductance, attributes.

Merged 2-phase interleaved DC-DC converter 1100 reduces the amount of inductance required for a 2:1 2 phase interleaved ReSC converter by 75% and number of inductors by 2 while keeping switching frequency and the size of the switching devices and capacitors the same. It can also achieve voltage regulation by operating at a plurality of different operating states, but has the added advantage of achieving 2-phase interleaving with only a single inductor.

Combinations of Features:

Features described above as well as those claimed below may be combined in various ways without departing from the scope hereof. The following examples illustrate some possible, non-limiting combinations:

(A1) A two-phase interleaved DC-DC converter, including a first and second switched capacitor sub-converter each including a flying capacitor, and a plurality of switching devices capable of coupling the flying capacitor in configurations including (i) between an input voltage node and a switching node, and (ii) between the switching node and ground; wherein the switching node of each of the first and second switched capacitor sub-converters are coupled together to form a common node; and an inductor coupled between the common node and an output node.

(A2) The two-phase interleaved DC-DC converter denoted (A1) above, wherein for each of the first and second switched capacitor sub-converters: the plurality of switching devices includes: (i) a first switching device electrically coupled between the input voltage node and a first flying node, (ii) a second switching device electrically coupled between the first flying node and the switching node, (iii) a third switching device electrically coupled between the switching node and a second flying node, and (iv) a fourth switching device electrically coupled between the second flying node and ground, and the flying capacitor is coupled between the first and second flying nodes.

(A3) In either of the two-phase interleaved DC-DC converters denoted (A1)-(A2) above, further comprising a controller capable of generating, for each of the first and second switched capacitor sub-converters: a first clock signal capable of controlling the first switching device, a second clock signal capable of controlling the second switching device, a third clock signal capable of controlling the third switching device, and a fourth clock signal capable of controlling the fourth switching device.

(A4) In the two-phase interleaved DC-DC converter denoted (A3) above, wherein the phases of the first, second, third, and fourth clock signals in the first switched-capacitor sub-converter are phase shifted by substantially 180 degrees from the respective first, second, third, and fourth clock signals in the second switched-capacitor sub-converter.

(A5) In either of the two-phase interleaved DC-DC converters denoted (A3)-(A4) above, wherein the first clock signal is in phase with the third clock signal and the second clock signal is in phase with the fourth clock signal and the first and third clock signals are complimentary with the second and fourth clock signals.

(A6) In any of the two-phase interleaved DC-DC converters denoted (A3)-(A5) above, wherein the first, second, third, and fourth clock signals operate at a resonant frequency.

(A7) In the two-phase interleaved DC-DC converter denoted (A6) above, wherein the resonant frequency corresponds to a frequency of the clock signals such that when the flying capacitor transitions between the configurations, the current in the inductor is substantially zero.

(A8) In either of the two-phase interleaved DC-DC converters denoted (A6)-(A7) above, wherein the resonant frequency is substantially equal to

$${f}_{0} = \frac{1}{2 π \sqrt{{L}_{X} ( 2 {C}_{X} )}} ;$$

where Lx is the inductance of the inductor, and Cx is the capacitance value of each of the flying capacitors of the first and second switched capacitor sub-converters.

(A9) In any of the two-phase interleaved DC-DC converters denoted (A1)-(A8) above, including a controller further capable of configuring the clock signals such that the converter operates in a plurality of states.

(A10) In the two-phase interleaved DC-DC converter denoted as (A9) above, wherein at least one of the plurality of states includes the flying capacitor of the second switched-capacitor sub-converter coupled between the input node and the switching node, and the flying capacitor of the first switched-capacitor sub-converter coupled between the switching node and ground, such that current from each of the flying capacitors flows through the inductor.

(A11) In either of the two-phase interleaved DC-DC converters denoted (A9)-(A10) above, wherein at least one of the plurality of states includes the flying capacitor of the second switched-capacitor sub-converter coupled between ground and the switching node, and the flying capacitor of the first switched-capacitor sub-converter coupled between the switching node and the input node, such that current from each of the flying portions flows through the inductor.

(A12) In any of the two-phase interleaved DC-DC converters denoted (A9)-(A11) above, wherein at least one of the plurality of states includes the output node coupled through the inductor to the input node.

(A13) In any of the two-phase interleaved DC-DC converters denoted (A9)-(A12) above, wherein at least one of the plurality of states includes the output node coupled through the inductor to ground.

(A14) In any of the two-phase interleaved DC-DC converters denoted (A9)-(A13) above, wherein the controller is further capable of configuring the clock signals such that a portion of the plurality of states operate at a resonant frequency.

(A15) In any of the two-phase interleaved DC-DC converters denoted (A6)-(A14) above, wherein the resonant frequency corresponds to a frequency of the clock signals such that when the flying capacitor transitions between the configurations, the current in the inductor is substantially zero.

(A16) In any of the two-phase interleaved DC-DC converters denoted (A3)-(A15) above, wherein the controller is capable of configuring the clock signals such that a portion of the plurality of states operate for a time period that is substantially shorter than a resonant time period.

(A17) In any of the two-phase interleaved DC-DC converters denoted (A1)-(A16) above, wherein a bypass capacitor is configured between the input voltage terminal and the output node, and a bypass capacitor is configured between the output node and ground.

(A18) In any of the two-phase interleaved DC-DC converters denoted (A1)-(A17) above, further comprising a first bypass capacitor coupled between the input voltage node and ground and a second bypass capacitor coupled between the output node and ground or the output node and the input voltage node.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A two-phase interleaved DC-DC converter, comprising:
a first and second switched capacitor sub-converter each including
a flying capacitor, and
a plurality of switching devices capable of coupling the flying capacitor in configurations including (i) between an input voltage node and a switching node, and (ii) between the switching node and ground;
wherein the switching node of each of the first and second switched capacitor sub-converters are coupled together to form a common node; and
an inductor coupled between the common node and an output node.

2. The converter of claim 1, wherein for each of the first and second switched capacitor sub-converters:
the plurality of switching devices comprises: (i) a first switching device electrically coupled between the input voltage node and a first flying node, (ii) a second switching device electrically coupled between the first flying node and the switching node, (iii) a third switching device electrically coupled between the switching node and a second flying node, and (iv) a fourth switching device electrically coupled between the second flying node and ground, and
the flying capacitor is coupled between the first and second flying nodes.

3. The converter of claim 2, further comprising a controller capable of generating, for each of the first and second switched capacitor sub-converters:
a first clock signal capable of controlling the first switching device,
a second clock signal capable of controlling the second switching device,
a third clock signal capable of controlling the third switching device, and
a fourth clock signal capable of controlling the fourth switching device.

4. The converter of claim 3, wherein the phases of the first, second, third, and fourth clock signals in the first switched-capacitor sub-converter are phase shifted by substantially 180 degrees from the respective first, second, third, and fourth clock signals in the second switched-capacitor sub-converter.

5. The converter of claim 3, wherein the first clock signal is in phase with the third clock signal and the second clock signal is in phase with the fourth clock signal and the first and third clock signals are complimentary with the second and fourth clock signals.

6. The converter of claim 5, wherein the first, second, third, and fourth clock signals operate at a resonant frequency.

7. The converter of claim 6, wherein the resonant frequency corresponds to a frequency of the clock signals such that when the flying capacitor transitions between the configurations, the current in the inductor is substantially zero.

8. The converter of claim 6, wherein the resonant frequency is substantially equal to
$${f}_{0} = \frac{1}{2 π \sqrt{{L}_{X} ( 2 {C}_{X} )}} ;$$
where Lx is the inductance of the inductor, and Cx is the capacitance value of each of the flying capacitors of the first and second switched capacitor sub-converters.

9. The converter of claim 3, the controller further capable of configuring the clock signals such that the converter operates in a plurality of states.

10. The converter of claim 9, wherein at least one of the plurality of states includes the flying capacitor of the second switched-capacitor sub-converter coupled between the input node and the switching node, and the flying capacitor of the first switched-capacitor sub-converter coupled between the switching node and ground, such that current from each of the flying capacitors flows through the inductor.

11. The converter of claim 9, wherein at least one of the plurality of states includes the flying capacitor of the second switched-capacitor sub-converter coupled between ground and the switching node, and the flying capacitor of the first switched-capacitor sub-converter coupled between the switching node and the input node, such that current from each of the flying portions flows through the inductor.

12. The converter of claim 9, wherein at least one of the plurality of states includes the output node coupled through the inductor to the input node.

13. The converter of claim 9, wherein at least one of the plurality of states includes the output node coupled through the inductor to ground.

14. The converter of claim 9, wherein the controller is further capable of configuring the clock signals such that a portion of the plurality of states operate at a resonant frequency.

15. The converter of claim 14, wherein the resonant frequency corresponds to a frequency of the clock signals such that when the flying capacitor transitions between the configurations, the current in the inductor is substantially zero.

16. The converter of claim 9, wherein the controller is capable of configuring the clock signals such that a portion of the plurality of states operate for a time period that is substantially shorter than a resonant time period.

17. The converter of claim 1, wherein a bypass capacitor is configured between the input voltage terminal and the output node, and a bypass capacitor is configured between the output node and ground.

18. The converter of claim 1, further comprising a first bypass capacitor coupled between the input voltage node and ground and a second bypass capacitor coupled between the output node and ground or the output node and the input voltage node.
